(19) United States
(12) Patent Application Publication
(10) Pub. No.: US 2016/0162431 A1
(43) Pub. Date: Jun. 9, 2016

(54) ELECTRONIC DEVICE WITH MULTIPLE INTERFACES

(71) Applicant: Transcend Information, Inc., Taipei (TW)

(72) Inventors: Hung-Wei Shen, New Taipei City (TW); Ren-Wei Chen, New Taipei City (TW)

(21) Appl. No.: 14/559,926

(22) Filed: Dec. 4, 2014

(51) Int. Cl. G06F 13/40; G06F 12/02; G06F 13/42

(52) U.S. Cl. CPC G06F 13/4072; G06F 13/4234; G06F 12/0246; G06F 2212/7208; G06F 2212/161; G06F 2212/171

(57) ABSTRACT

An electronic device with multiple interfaces includes at least two interfaces, a memory, and a controller. The memory stores a first operation setting parameter group corresponding to a first device and a second operation setting parameter group corresponding to a second device. The controller is electrically connected to the first interface, the second interface, and the memory. When a first interface of the at least two interface is electrically connected to the first device, the controller loads the first operation setting parameter group and utilizes a first transmission protocol and the first operation setting parameter group to communicate the first device; and when a second interface of the at least two interface is electrically connected to the second device, the controller loads the second operation setting parameter group and utilizes a second transmission protocol and the second operation setting parameter group to communicate the second device.

### BACKGROUND

1. Technical Field

The present invention relates to an electronic device with multiple interfaces, and particularly to an electronic device whose controller can load one of operation setting parameter groups stored in the memory corresponding to a device when the device is electrically connected to one interface of the electronic device.

2. Description of the Conventional Art

Generally speaking, a Universal Serial Bus (USB) flash drive designed for a mobile phone usually has two interfaces (e.g. one interface of the two interfaces is a Micro-B USB interface for connecting to the mobile phone, and the other interface of the two interfaces is a Type-A USB interface for connecting to a computer). However, operation parameters of the USB flash drive when the USB flash drive is electrically connected to the computer are slightly different from operation parameters of the USB flash drive when the USB flash drive is electrically connected to the mobile phone. For example, when the USB flash drive is electrically connected to the computer, the computer can accept larger current parameter; and when the USB flash drive is electrically connected to the mobile phone, the mobile phone only can accept smaller current parameter. In the prior art, the USB flash drive utilizes the same current parameter (that is, the smaller current parameter) to let the two interfaces normally operate when one of the two interfaces is electrically connected to a device (e.g. the computer or the mobile phone). Although the computer can accept the smaller current parameter, the computer may utilize lower performance to access the USB flash drive according to the smaller current parameter. Therefore, it is not a good choice for a user that the USB flash drive utilizes the same current parameter to let the two interfaces normally operate.

### SUMMARY

An embodiment provides an electronic device with multiple interfaces. The electronic device includes at least two interfaces, a memory, and a controller. The memory stores a first operation setting parameter group corresponding to a first device and a second operation setting parameter group corresponding to a second device. The controller is electrically connected to the first interface, the second interface, and the memory. When a first interface of the at least two interface is electrically connected to the first device, the controller loads the first operation setting parameter group and utilizes a first transmission protocol and the first operation setting parameter group to communicate the first device; and when a second interface of the at least two interface is electrically connected to the second device, the controller loads the second operation setting parameter group and utilizes a second transmission protocol and the second operation setting parameter group to communicate the second device.

Another embodiment provides an operation method of an electronic device with multiple interfaces, wherein the electronic device includes at least two interfaces, a memory, and a controller, and the memory stores a first operation setting parameter group corresponding to a first device and a second operation setting parameter group corresponding to a second device. The operation method includes when a first interface of the at least two interface is electrically connected to the first device, the controller loading the first operation setting parameter group; and after the controller loads the first operation setting parameter group, the controller utilizing a first transmission protocol and the first operation setting parameter group to communicate the first device.

Another embodiment provides an operation method of an electronic device with multiple interfaces, wherein the electronic device includes at least two interfaces, a memory, and a controller, and the memory stores a first operation setting parameter group corresponding to a first device and a second operation setting parameter group corresponding to a second device. The operation method includes when a second interface of the at least two interface is electrically connected to the second device, the controller loading the second operation setting parameter group; and after the controller loads the second operation setting parameter group, the controller utilizing a second transmission protocol and the second operation setting parameter group to communicate the second device.

The present invention provides an electronic device with multiple interfaces. The electronic device has advantages as follows: first, because a first interface and a second interface of the electronic device share a common power transmission path, a common data transmission path, and a controller, the electronic device can be implemented easily and only increase minor load on the controller; second, because the first interface and the second interface share the common power transmission path, the common data transmission path, and the controller, the electronic device has simpler structure; third, the present invention can be applied to any electronic device with multiple interfaces; and fourth, the controller can determine to load one of operation setting parameter groups stored in a memory corresponding to a device when the device is electrically connected to one interface of the electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device with multiple interfaces according to an embodiment.

FIG. 2 is a diagram illustrating the selecting unit being a transmission gate.

FIG. 3 is a diagram illustrating the first interface being electrically connected to a first device.

FIG. 4 is a diagram illustrating the second interface being electrically connected to a second device.

FIG. 5 is a diagram illustrating an electronic device with multiple interfaces according to another embodiment.

FIG. 6 and FIG. 7 are diagrams illustrating the memory being a read-only memory inside the controller.

FIG. 8 is a flowchart illustrating an operation method of an electronic device with multiple interfaces according to another embodiment.

### DETAILED DESCRIPTION

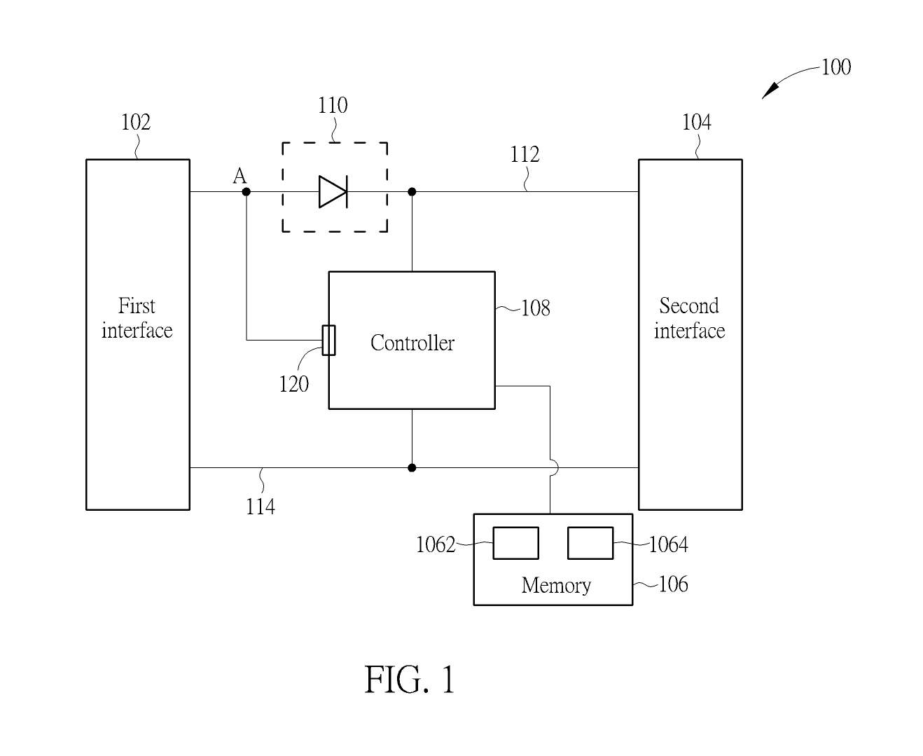

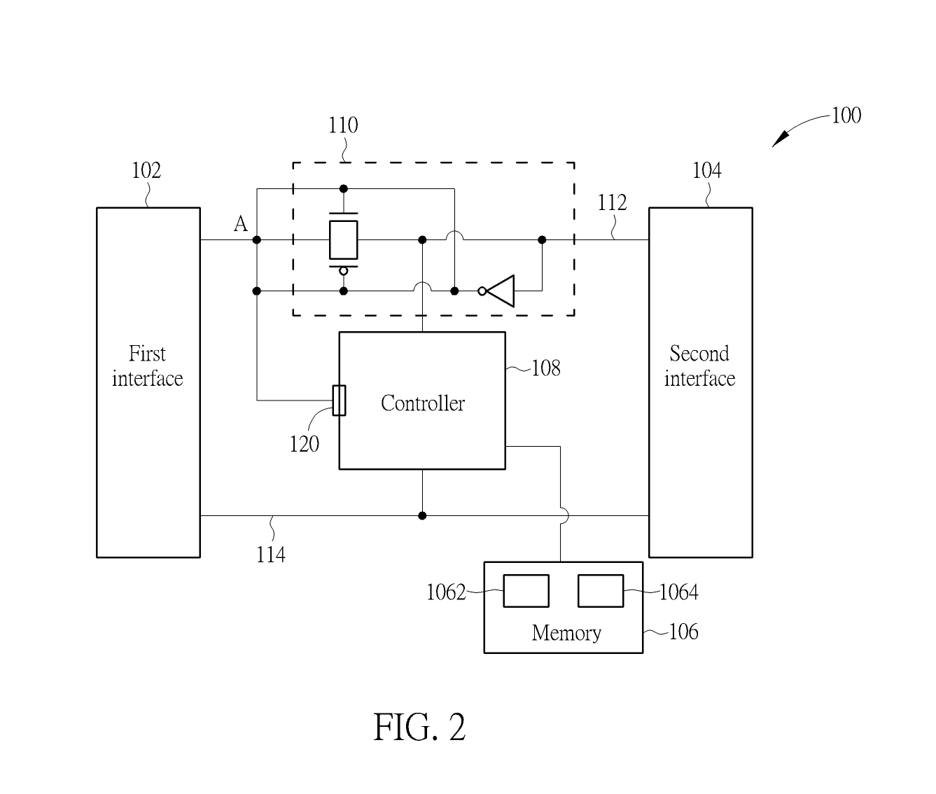

Please refer to FIG. 1. FIG. 1 is a diagram illustrating an electronic device 100 with multiple interfaces according to an embodiment. As shown in FIG. 1, the electronic device 100 includes a first interface 102, a second interface 104, a memory 106, a controller 108, and a selecting unit 110, wherein the controller 108 is electrically connected to the first interface 102, the second interface 104, and the memory 106, the memory 106 pre-stores a first operation setting parameter group 1062 and a second operation setting parameter group 1064, the first interface 102 is a Type-A Universal Serial Bus (USB) interface and the second interface 104 is a Micro-B USB interface, and the memory 106 is a storage device (e.g. flash memory). But, the present invention is not limited to the first interface 102 being a Type-A USB interface and the second interface 104 being a Micro-B USB interface, and the electronic device 100 only including the first interface 102 and the second interface 104. That is to say, the electronic device 100 can include at least two interfaces. Further, the first interface 102 and the second interface 104 can share a common power transmission path 112, a common data transmission path 114, and the controller 108. Further, as shown in FIG. 1, the selecting unit 110 is a diode. But, the present invention is not limited to the selecting unit 110 being a diode. For example, the selecting unit 110 can also be a transmission gate (as shown in FIG. 2).

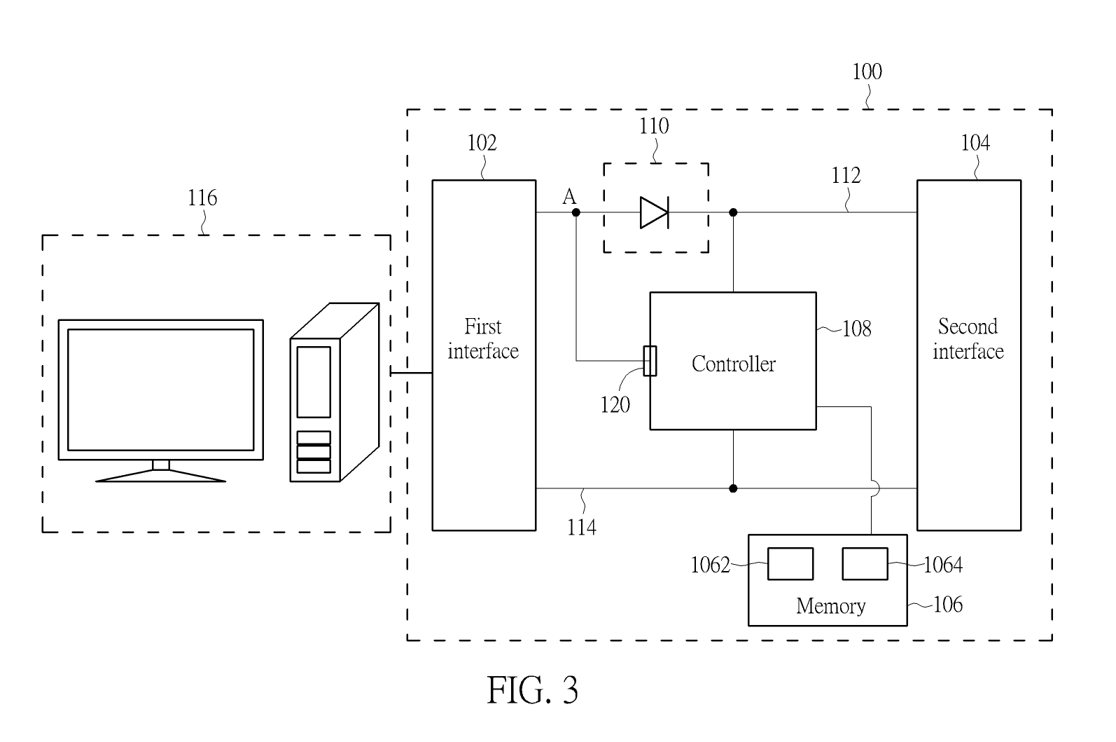

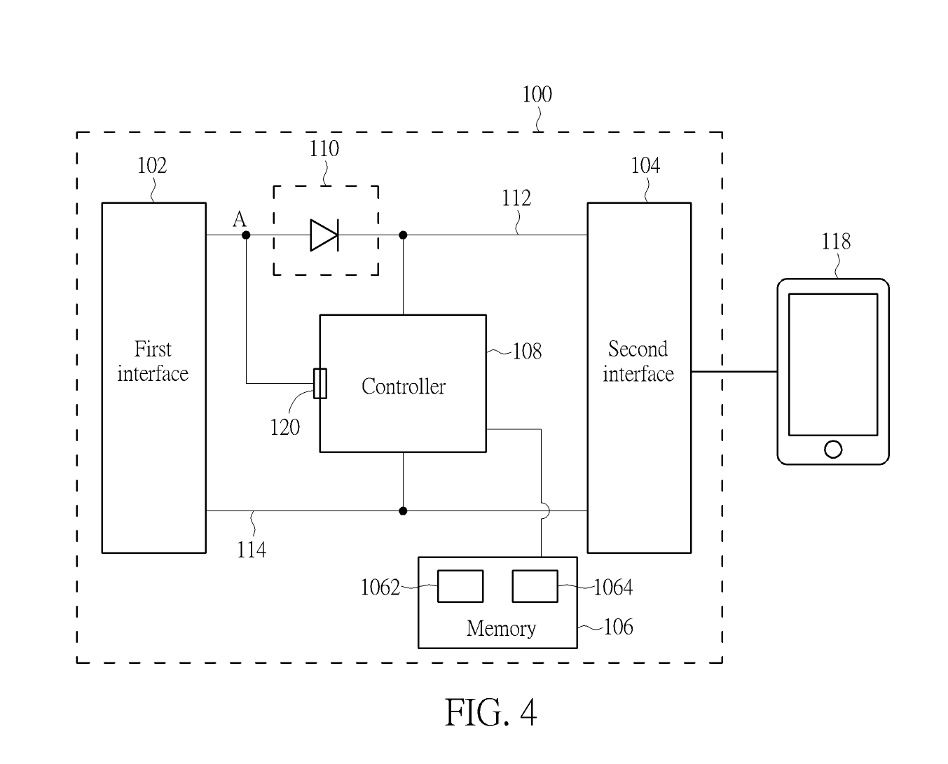

Please refer to FIG. 3 and FIG. 4. FIG. 3 is a diagram illustrating the first interface 102 being electrically connected to a first device 116, and FIG. 4 is a diagram illustrating the second interface 104 being electrically connected to a second device 118. As shown in FIG. 3, when the first interface 102 is electrically connected to the first device 116 (e.g. a computer), a potential of a point A is high, so the first device 116 can charge the controller 108 through the selecting unit 110, and a potential of a predetermined pin 120 (e.g. General Purpose Input/Output (GPIO) pin) of the controller 108 is also high. But, the present invention is not limited to the predetermined pin 120 being a GPIO pin. Because the potential of the predetermined pin 120 of the controller 108 is high, the controller 108 can load the first operation setting parameter group 1062 according to the high potential of the predetermined pin 120 and utilize a first transmission protocol and the first operation setting parameter group 1062 to communicate the first device 116, wherein the first operation setting parameter group 1062 corresponds to the first device 116, the first transmission protocol corresponds to the Type-A USB interface, and the first transmission protocol includes a combination of operation speed (e.g. transmission frequency or processing frequency), power consumption, access data mode(e.g. read-only mode or not read-only mode) of the electronic device 100. For example, the first operation setting parameter group 1062 can include an operation current parameter 700 mA, a controller operation clock 200 MHz, normal read/write, and so on. Therefore, under the first transmission protocol and the first operation setting parameter group 1062, the first device 116 can read data stored in the memory 106 or write data in the memory 106 in higher speed through the controller 108 and the first interface 102. Further, in another embodiment of the present invention, the first operation setting parameter group 1062 can be first firmware for the electronic device 100 operating when the first interface 102 of the electronic device 100 is electrically connected to the first device 116.

As shown in FIG. 4, when the second interface 104 is electrically connected to the second device 118 (e.g. a mobile phone), the second device 118 can directly charge the controller 108 and the potential of the predetermined pin 120 of the controller 108 is low. Because the potential of the predetermined pin 120 of the controller 108 is low, the controller 108 can load the second operation setting parameter group 1064 and utilize a second transmission protocol and the second operation setting parameter group 1064 to communicate the second device 118, wherein the second operation setting parameter group 1064 corresponds to the second device 118, the second transmission protocol corresponds to the Micro-B USB interface, and the second transmission protocol includes a combination of another operation speed, another power consumption, another access data mode of the electronic device 100. For example, the second operation setting parameter group 1064 can include an operation current parameter 400 mA, a controller operation clock 150 MHz, only read, and so on. Therefore, under the second transmission protocol and the second operation setting parameter group 1064, the second device 118 can read data stored in the memory 106 in lower speed through the controller 108 and the second interface 104. Further, because the operation current parameter (700 mA) and the controller operation clock (200 MHz) of the first operation setting parameter group 1062 are higher than the operation current parameter (400 mA) and the controller operation clock (150 MHz) of the second operation setting parameter group 1064, a temperature of the electronic device 100 operating under the first operation setting parameter group 1062 will be higher than a temperature of the electronic device 100 operating under the second operation setting parameter group 1064. Further, in another embodiment of the present invention, the second operation setting parameter group 1064 can be second firmware for the electronic device 100 operating when the second interface 104 of the electronic device 100 is electrically connected to the second device 118.

In addition, in another embodiment of the present invention, the electronic device 100 further acts as a mobile power pack. When the electronic device 100 acts as the mobile power pack, the first operation setting parameter group 1062 further includes a charging voltage 5 V and a charging current 3 A, and the second operation setting parameter group 1064 further includes a charging voltage 5 V and a charging current 1 A. Therefore, When the electronic device 100 acts as the mobile power pack and the first interface 102 is electrically connected to the first device 116 (e.g. a tablet personal computer), the electronic device 100 can fast charge the first device 116 under the first operation setting parameter group 1062 (e.g. the charging voltage 5 V and the charging current 3 A); and when the electronic device 100 acts as the mobile power pack and the second interface 104 is electrically connected to the second device 118 (e.g. a mobile phone), the electronic device 100 can normally charge the second device 118 under the second operation setting parameter group 1064 (e.g. the charging voltage 5 V and the charging current 1 A). Further, when the electronic device 100 acts as the mobile power pack, the common data transmission path 114 of the electronic device 100 is optional.

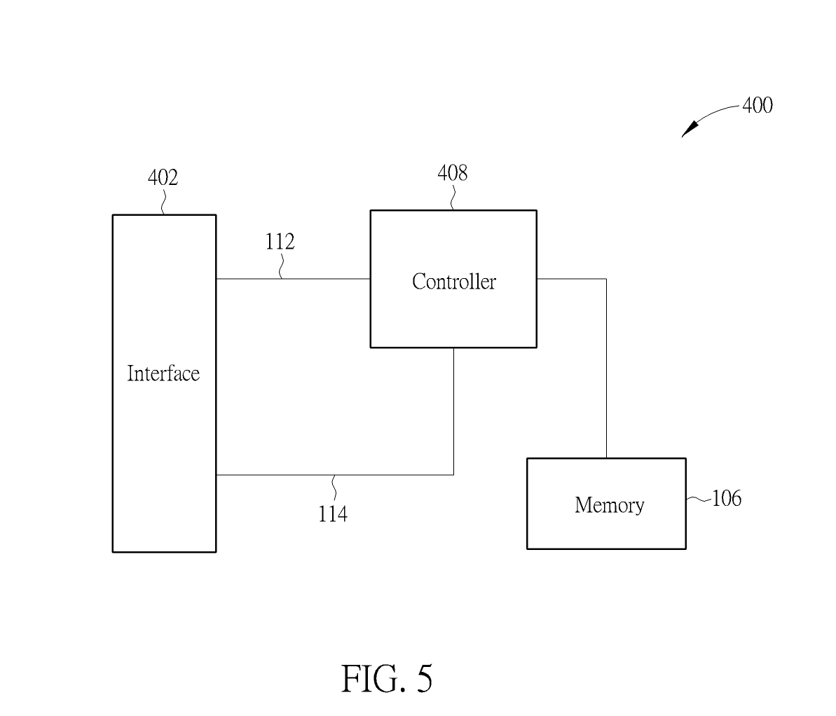

Please refer to FIG. 5. FIG. 5 is a diagram illustrating an electronic device 400 with multiple interfaces according to another embodiment. As shown in FIG. 5, differences between the electronic device 400 and the electronic device 100 are that the first interface 102 (e.g. Type-A USB interface) and the second interface 104 (e.g. Micro-B USB interface) of the electronic device 100 are integrated into an interface 402, and the selecting unit 110 of the electronic device 100 is integrated into the controller 408. Therefore, when the interface 402 is electrically connected to the first device 116 (e.g. a computer), the first device 116 can charge the controller 108, and the controller 108 can load the first operation setting parameter group 1062 according to the first device 116 and utilizes the first transmission protocol and the first operation setting parameter group 1062 to communicate the first device 116, wherein the first operation setting parameter group 1062 corresponds to the first device 116 and the first transmission protocol corresponds to the Type-A USB interface. For example, the first operation setting parameter group 1062 includes an operation current parameter 700 mA, a controller operation clock 200 MHz, normal read/write, and so on. Therefore, under the first transmission protocol and the first operation setting parameter group 1062, the first device 116 can read data stored in the memory 106 or write data in the memory 106 in higher speed through the controller 108 and the first interface 102. When the interface 402 is electrically connected to the second device 118 (e.g. a mobile phone), the second device 118 can charge the controller 108 and the controller 108 can load the second operation setting parameter group 1064 and utilizes a second transmission protocol and the second operation setting parameter group 1064 to communicate the second device 118, wherein the second operation setting parameter group 1064 corresponds to the second device 118 and the second transmission protocol corresponds to the Micro-B USB interface. For example, the second operation setting parameter group 1064 includes an operation current parameter 400 mA, a controller operation clock 150 MHz, only read, and so on. Therefore, under the second transmission protocol and the second operation setting parameter group 1064, the second device 118 can read data stored in the memory 106 in lower speed through the controller 108 and the second interface 104. Further, subsequent operational principles of the electronic device 400 are the same as those of the electronic device 100, so further description thereof is omitted for simplicity.

In addition, in another embodiment of the present invention, the electronic device 400 further acts as a mobile power pack. Because operational principles of the electronic device 400 are the same as those of the electronic device 100 when the electronic device 400 acts as the mobile power pack, so further description thereof is omitted for simplicity.

Further, in another embodiment of the present invention, the interface 402 integrates a Secure Digital (SD) card interface with a Multimedia Card (MMC card) interface, so when the interface 402 is electrically connected to a Secure Digital (SD) card, the controller 108 can load a third operation setting parameter group stored in the memory 106 according to the SD card and utilize a third transmission protocol and the third operation setting parameter group to communicate the SD card, wherein the third operation setting parameter group corresponds to the SD card and the third transmission protocol corresponds to the SD card interface. Further, when the interface 402 is electrically connected to a Multimedia Card (MMC card), the controller 108 can load a fourth operation setting parameter group stored in the memory 106 according to the MMC card and utilize a fourth transmission protocol and the fourth operation setting parameter group to communicate the MMC card, wherein the fourth operation setting parameter group corresponds to the MMC card and the fourth transmission protocol corresponds to the MMC card interface.

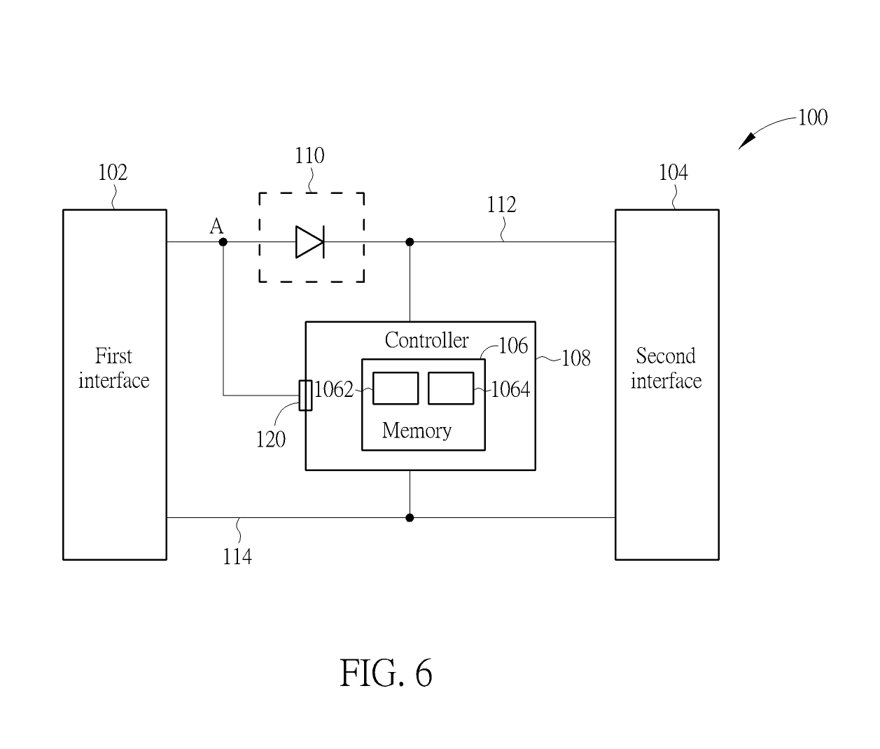

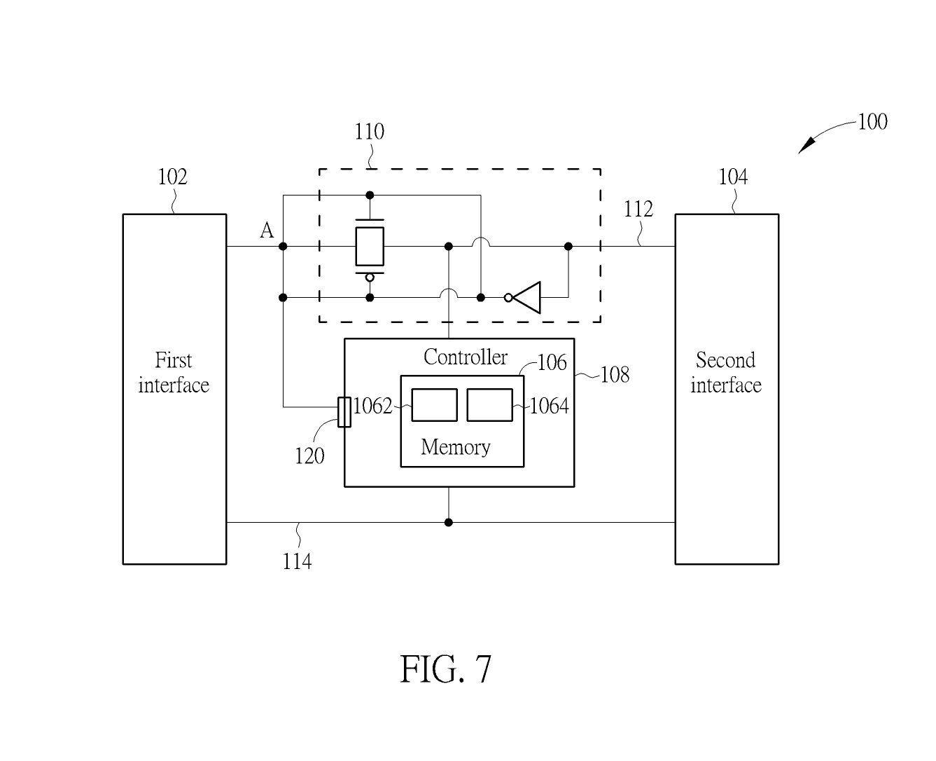

Further, when the first operation setting parameter group 1062 is the first firmware and the second operation setting parameter group 1064 is the second firmware, the memory 106 can be a read-only memory inside the controller 108, wherein the first firmware and the firmware are stored in the read-only memory (as shown in FIG. 6 and FIG. 7). That is to say, because the first firmware and the firmware are stored in the read-only memory, a user cannot change the first firmware and the firmware.

Further, because the controller 108 can load the first operation setting parameter group 1062 when the first interface 102 is electrically connected to the first device 116 and load the second operation setting parameter group 1064 when the second interface 104 is electrically connected to the second device 118, in another embodiment of the present invention, the controller 108 can have at least two operation cores, wherein one of the at least two operation cores operates according to the first operation setting parameter group 1062 when the first interface 102 is electrically connected to the first device 116, and another one of the at least two operation cores operates according to the second operation setting parameter group 1064 when the second interface 104 is electrically connected to the second device 118. Further, in another embodiment of the present invention, the controller 108 can have one operation core, wherein the operation core operates according to the first operation setting parameter group 1062 when the first interface 102 is electrically connected to the first device 116, and the operation core operates according to the second operation setting parameter group 1064 when the second interface 104 is electrically connected to the second device 118.

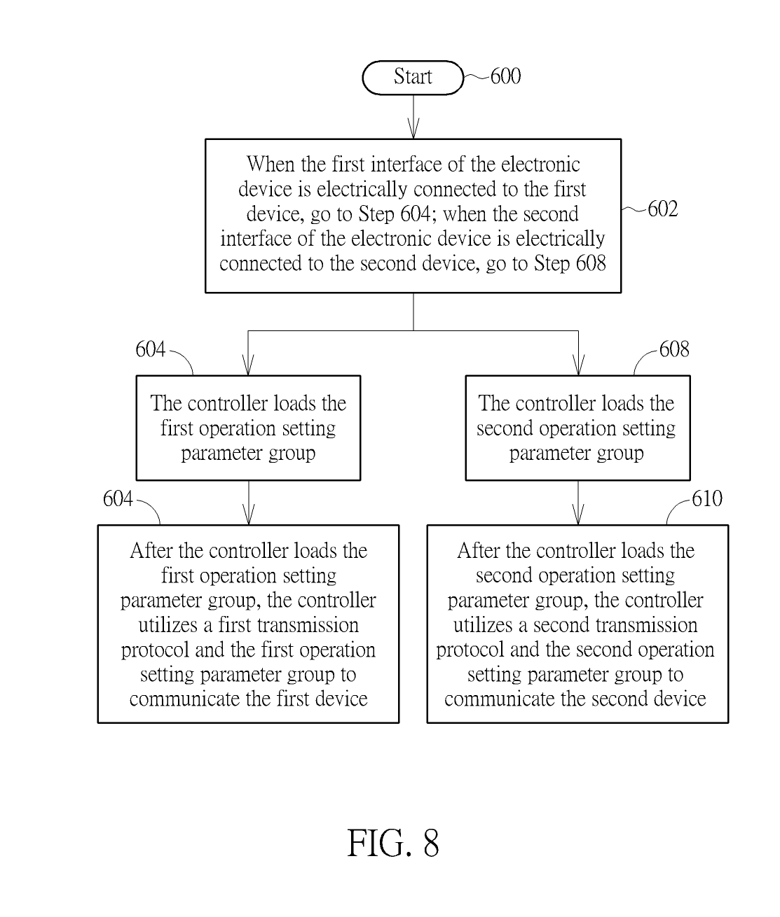

Please refer to FIGS. 1, 3, 4, 8. FIG. 8 is a flowchart illustrating an operation method of an electronic device with multiple interfaces according to another embodiment. The method in FIG. 8 is illustrated using the electronic device 100 in FIG. 1. Detailed steps are as follows:

Step 600: Start.

Step 602: When the first interface 102 of the electronic device 100 is electrically connected to the first device 116, go to Step 604; when the second interface 104 of the electronic device 100 is electrically connected to the second device 118, go to Step 608.

Step 604: The controller 108 loads the first operation setting parameter group.

Step 606: After the controller 108 loads the first operation setting parameter group, the controller 108 utilizes a first transmission protocol and the first operation setting parameter group to communicate the first device 116.

Step 608: The controller 108 loads the second operation setting parameter group.

Step 610: After the controller 108 loads the second operation setting parameter group, the controller 108 utilizes a second transmission protocol and the second operation setting parameter group to communicate the second device 118.

In Step 604, as shown in FIG. 3, when the first interface 102 is electrically connected to the first device 116, the potential of the point A is high, so the first device 116 can charge the controller 108 through the selecting unit 110, and the potential of the predetermined pin 120 of the controller 108 is also high. Because the potential of the predetermined pin 120 of the controller 108 is high, the controller 108 can load the first operation setting parameter group 1062 according to the high potential of the predetermined pin 120. In Step 606, after the controller 108 loads the first operation setting parameter group, the controller 108 utilize the first transmission protocol and the first operation setting parameter group 1062 to communicate the first device 116, wherein the first operation setting parameter group 1062 corresponds to the first device 116. Therefore, under the first transmission protocol and the first operation setting parameter group 1062, the first device 116 can read data stored in the memory 106 or write data in the memory 106 in higher speed through the controller 108 and the first interface 102.

In Step 608, as shown in FIG. 4, when the second interface 104 is electrically connected to the second device 118, the second device 118 can directly charge the controller 108 and the potential of the predetermined pin 120 of the controller 108 is low. Because the potential of the predetermined pin 120 of the controller 108 is low, the controller 108 can load the second operation setting parameter group 1064. In Step 610, after the controller 108 loads the second operation setting parameter group, the controller 108 utilize the second transmission protocol and the second operation setting parameter group 1064 to communicate the second device 118, wherein the second operation setting parameter group 1064 corresponds to the second device 118. Therefore, under the second transmission protocol and the second operation setting parameter group 1064, the second device 118 can read data stored in the memory 106 in lower speed through the controller 108 and the second interface 104.

To sum up, the electronic device has advantages as follows: first, because the first interface and the second interface share the common power transmission path, the common data transmission path, and the controller, the electronic device can be implemented easily and only increase minor load on the controller; second, because the first interface and the second interface share the common power transmission path, the common data transmission path, and the controller, the electronic device has simpler structure; third, the present invention can be applied to any electronic device with multiple interfaces; and fourth, the controller can determine to load one of operation setting parameter groups stored in the memory corresponding to a device when the device is electrically connected to one interface of the electronic device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device with multiple interfaces, comprising:
at least two interfaces;
a memory, wherein the memory stores a first operation setting parameter group corresponding to a first device and a second operation setting parameter group corresponding to a second device; and
a controller electrically connected to the first interface, the second interface, and the memory;
wherein when a first interface of the at least two interface is electrically connected to the first device, the controller loads the first operation setting parameter group and utilizes a first transmission protocol and the first operation setting parameter group to communicate the first device; and when a second interface of the at least two interface is electrically connected to the second device, the controller loads the second operation setting parameter group and utilizes a second transmission protocol and the second operation setting parameter group to communicate the second device.

2. The electronic device of the claim 1, wherein the first interface is a Type-A Universal Serial Bus (USB) interface and the second interface is a Micro-B USB interface.

3. The electronic device of the claim 2, wherein the memory further stores data.

4. The electronic device of the claim 1, further comprising:
a selecting unit, wherein when the first interface is electrically connected to the first device, the first device charges the controller through the selecting unit, and a potential of a predetermined pin of the controller is high;
wherein when the potential of the predetermined pin of the controller is high, the controller loads the first operation setting parameter group.

5. The electronic device of the claim 4, wherein when the second interface is electrically connected to the second device, the second device charges the controller and the potential of the predetermined pin of the controller is low, wherein when the potential of the predetermined pin of the controller is low, the controller loads the second operation setting parameter group.

6. The electronic device of the claim 4, wherein the selecting unit is a diode.

7. The electronic device of the claim 4, wherein the predetermined pin is General Purpose Input/Output (GPIO) pin.

8. The electronic device of the claim 4, wherein the selecting unit is integrated into the controller.

9. The electronic device of the claim 8, wherein the second interface is integrated into the first interface.

10. The electronic device of the claim 9, wherein the first interface is a Type-A USB interface and the second interface is a Micro-B USB interface.

11. The electronic device of the claim 9, wherein the first interface is a Secure Digital (SD) card interface and the second interface is a Multimedia Card (MMC card) interface, wherein the first operation setting parameter group is for a SD card and the second operation setting parameter group is for a Multimedia Card.

12. The electronic device of the claim 1, wherein the memory is a flash memory.

13. The electronic device of the claim 1, wherein the first transmission protocol comprises a combination of operation speed, power consumption, access data mode of the electronic device.

14. The electronic device of the claim 1, wherein the second transmission protocol comprises a combination of operation speed, power consumption, access data mode of the electronic device.

15. An operation method of an electronic device with multiple interfaces, wherein the electronic device comprises at least two interfaces, a memory, and a controller, and the memory stores a first operation setting parameter group corresponding to a first device and a second operation setting parameter group corresponding to a second device, the operation method comprising:
when a first interface of the at least two interface is electrically connected to the first device, the controller loading the first operation setting parameter group; and
after the controller loads the first operation setting parameter group, the controller utilizing a first transmission protocol and the first operation setting parameter group to communicate the first device.

16. The operation method of the claim 15, wherein when the first interface is electrically connected to the first device, the first device charges the controller through a selecting unit further comprised by the electronic device, and a potential of a predetermined pin of the controller is high; wherein when the potential of the predetermined pin of the controller is high, the controller loads the first operation setting parameter group.

17. The operation method of the claim 15, wherein the first transmission protocol comprises a combination of operation speed, power consumption, read-only mode, access data mode of the electronic device.

18. An operation method of an electronic device with multiple interfaces, wherein the electronic device comprises at least two interfaces, a memory, and a controller, and the memory stores a first operation setting parameter group corresponding to a first device and a second operation setting parameter group corresponding to a second device, the operation method comprising:
when a second interface of the at least two interface is electrically connected to the second device, the controller loading the second operation setting parameter group; and
after the controller loads the second operation setting parameter group, the controller utilizing a second transmission protocol and the second operation setting parameter group to communicate the second device.

19. The operation method of the claim 18, wherein when the second interface is electrically connected to the second device, the second device charges the controller and the potential of the predetermined pin of the controller is low, wherein when the potential of the predetermined pin of the controller is low, the controller loads the second operation setting parameter group.

20. The operation method of the claim 18, wherein the second transmission protocol comprises a combination of operation speed, power consumption, read-only mode, access data mode of the electronic device.
